(19) United States
(12) Patent Application Publication
(10) Pub. No.: US 2006/0270383 A1
(43) Pub. Date: Nov. 30, 2006

(54) Low bandwidth asynchronous remote-use data capture and telecommunications system and apparatus

(76) Inventors: Dean Yergens, Alberta (CA); Douglas Hamilton, Seabrook, TX (US)

Correspondence Address: Schwegman, Lundberg, Woessner & Kluth, P.A., P.O. Box 2938, Minneapolis, MN, 55402, US

(21) Appl. No.: 11/365,220

(22) Filed: Feb. 28, 2006

Related U.S. Application Data
(60) Provisional application No. 60/657,583, filed on Feb. 28, 2005.

(51) Int. Cl. H04M 11/04

(52) U.S. Cl. 455/404.1

(57) ABSTRACT

The present invention relates generally to the provision of robust telecommunication to and from remote areas without reliably operating infrastructure such as electrical distribution power grid, telephone networks, and the like using a novel combination of equipment with a reduced data set and transmission protocols. The invention may be used in remote areas by lightly trained personnel or may be connected to remote unmanned sensors, and permits the collection of data from the field and the communication of signals back to the field.

### CROSS REFERENCE TO RELATED APPLICATIONS

This application claims the benefit of U.S. Provisional Application No. 60/657,583, filed Feb. 28, 2005, which is incorporated herein by reference.

### FIELD OF THE INVENTION

The present invention relates generally to the provision of robust telecommunication to and from remote areas without reliably operating infrastructure such as electrical distribution power grid, telephone networks, and the like using a novel combination of equipment with a reduced data set and transmission protocols. The invention may be used in remote areas by lightly trained personnel or may be connected to remote unmanned sensors, and permits the collection of data from the field and the communication of signals back to the field.

### BACKGROUND OF THE INVENTION

Public Health Surveillance in developing countries is a considerable challenge considering the lack of infrastructure in remote areas and the lack of appropriate funding to tackle this issue.

Most emergency based systems require land based cell phone, internet connectivity or radio assets pre-deployed to accomplish the same level of bidirectional communication in developing countries. Since the necessary infrastructure is typically not available in these environments there is a need for a new approach.

### SUMMARY OF THE INVENTION

The development of a system capable of monitoring health surveillance as well as responding to emergency events that is economical, robust and can be implemented world-wide in all environments, regardless of infrastructure is an object of the present invention, referred to as the Global Surveillance and Emergency Response System (GuSERS).

There are, of course, other uses which have been identified, once the system was conceived and tested. This disclosure is meant to be exemplary of the system and its related apparatus and operation, but the use of the system in remote healthcare surveillance in public health settings, or disaster recovery or emergencies is not meant to be limiting.

Other situations with similar requirements are common, and the system would also have utility in those settings. Examples of settings with unreliable or non-existent infrastructure include (but are not limited to): remote equipment monitoring, simple monitor/command/control or SCADA systems, meteorological data collection systems, Homeland defence, tsunami and hurricane disaster monitoring, burglar alarms for cabins, medical devices like glucose meters, insulin pumps and coagulation meters, pipeline controllers in the desert or cathodic protection of buried assets, to name a few.

The Global Surveillance and Emergency Response System (GuSERS) was developed around three “core” technologies which comprise:

A remote work station consisting of a communication device such as a Bi-directional satellite pager, uni-directional satellite pager, cellular device or other communication device which serves as the communication device sometimes with a PDA or other computerized device which can serve as a remote user interface.

A “non-verbose” bi-directional or uni-directional messaging standard that can convey a message or command and a geographical and temporal reference about where the message was composed.

Internet based information management system with Geographical Information System and intelligent software capabilities.

The inventors of the GuSERS considered the environment, both geographical and economical, in which developing countries were and still are functioning and addressed the issues that are being faced. Public health issues such as health surveillance and emergency response were deemed a major priority for the system as they could be implemented in a cost effective manner utilizing low-bandwidth technology and integrated internet-based systems.

The Global Surveillance and Emergency Response System (GuSERS) shows how a new combination of various technologies can create an effective and economical way to communicate with remote locations throughout the world serve the needs of public health surveillance and emergency and disaster response.

More specifically, a preferred embodiment of the present system utilizes a combination of technologies that includes a base station consisting of a solar panel trickled-charger, wind powered charger or thermal electric charger for a battery powered bi-directional satellite pager enabled for short text messaging, and a personal digital assistant (PDA) which communicates remotely with an internet based information management system with embedded geographical information system (GIS) to form the Global Surveillance and Emergency Response system (GuSERS).

The invention does not require any pre-deployed land based bidirectional network infrastructure or communication assets. It uses satellite-based communication which is accessible anywhere in the world, in its preferred embodiment. The PDA-like interface can interact with the remote user using any number of human factors approaches, such as any written or symbolic language. It can also use a multimedia interface to accommodate almost any level of training, ability, disability or education. The ability to communicate with the remote workstation using an internet based information management system additionally allows for messages to be sent and received anywhere there is internet access. The satellite-based pager used in this embodiment also delivers accurate remote workstation location, using Global Positioning System (GPS) technology.

The GuSERS system is capable of successfully performing a closed-looped test where a remote GuSERS base station located where no electrical or telecommunications infrastructure exist can communicate with an internet-based information management system in a cost effective manner.

This unique low-bandwidth communication system presents a very cost effective approach to provide public health surveillance and emergency response information in developing countries or where infrastructure is lacking or non-functional. This approach can be expanded to other kinds of low bandwidth solutions for humanitarian crises due to its mobile and open architecture, or for use in simple machine to machine interaction such as oil pipeline controllers or remote environmental sensors and/or warning systems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of an embodiment of the system in accordance with the present system.

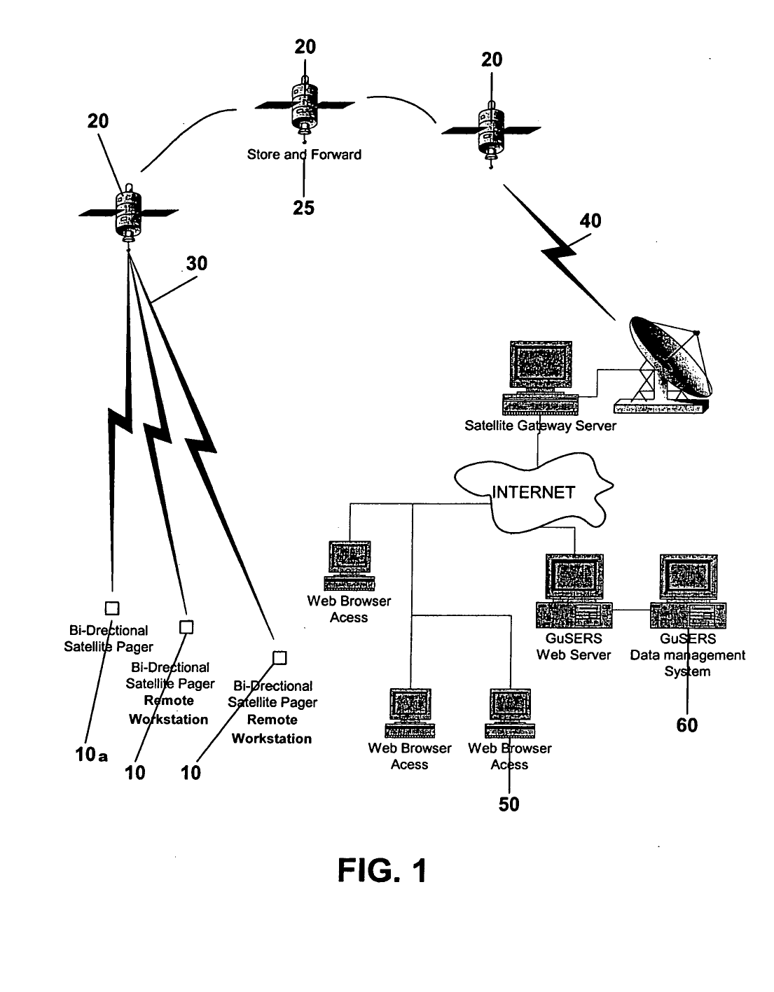

### DETAILED DESCRIPTION

The Global Surveillance and Emergency Response System (GuSERS) was developed around three “core” technologies.

These components comprise:

A remote work station consisting of a communication device such as a Bi-directional satellite pager 10, uni-directional satellite pager, cellular device or other communication device which serves as the communication device and a PDA or other computerized device which serves as the remote user interface.

A “non-verbose” bi-directional or uni-directional messaging standard that can convey a message or command or a geographical and temporal reference from where the message was composed remotely.

Internet based information management system 60 with Geographical Information System programmable and intelligent software capabilities.

Remote Workstation

The preferred embodiment of the GuSERS system includes a bi-directional satellite pager and an interface PDA 10, otherwise known as the “remote workstation” (RW). The RW acts as the interface between the user in the field and the Internet-based information management system 60. The RW 10 may be any device that includes a communication device (i.e. satellite, cellular, terrestrial, etc.) that interacts with a computized device.

The RW 10 has several features:

The RW 10 is completely independent of the built infrastructure of the environment in which it will be operating. The RW 10 is functional in an environment where an existing land-based telecommunications system may or may not exist or may be unreliable due to environmental or political factors. Wired networks, and which include cellular networks are both problematic, as often cellular networks are located in urban areas and are not found in remote areas, due to the commercial viability of implementing a network in such an environment. In those settings, one reliable communication backbone that can be used is satellite based.

The RW 10 can also be independent of an electrical infrastructure and can be supplemented with other forms of electrical power/charging systems such as solar power. To ensure that during times of power outages, which are frequent in developing countries, or in a remote environment where again the electrical infrastructure may be non-existent or unreliable, the RW 10 could continue to operate if it can be charged with solar, wind, or similar “off-grid” electrical-generation devices.

The RW 10 also has the ability to convey 30, 40 a message in a meaningful matter to an Internet-based information management system 60. The message is encapsulated into the satellite based pager message structure, providing the ability to be collated and grouped with other similarly tagged messages and finally have the ability to contain a geographical or temporal reference, in addition to carrying incident information. Since geographic location is usually an essential requirement, the RW 10 needs some way to communicate its latitude and longitude either in its messages or triangulated from where the message was received through the satellite network.

The RW 10 needs to be economical, both in terms of the capital cost as well as on-going operating costs. The capital cost of the RW 10 has to be affordable in terms of populating a geographical area with RW stations 10, 10a. The GuSERS system will most likely consist of several RW's 10, 10a occupying a geographical region as opposed to one RW acting as the information hub for a given region. Many telehealth systems, due to their costs, are economically unviable for multi-node remote monitoring networks. An example of a competing system might be a telehealth system that relies on a high-bandwidth satellite connection, determined to be more than 33.6 kps for an extended period of time.

There is an additional set of requirements related to the physical characteristic of the RW 10. It was determined that it had to be robust enough to exist in a remote environment, require little or no maintenance and preferably be portable. The RW 10 preferably can function in excessive heat and the casing and all components of the device, such as the keyboard and the antenna of the device, can also stand up to continued used in a remote environment.

The RW 10 in the preferred embodiment was a commercial low bandwidth bi-directional satellite pager, a commercial PDA and a purpose-built power supply for both. The remote energy supply may be a battery based power supply which is able to be recharged through a multitude of available energy sources (not shown). To offset the electrical infrastructure difficulties a solar power tickle charger was built for the prototype to allow the RW 10 to charge itself. Commercial solar power panels were initially selected based upon a factor of cost and the ability of how long it would take to recharge the unit. As the RW 10, 10a has the capability to be mobile, flexible solar power panels were used. This presented another advantage, as the solar power panel could be rolled up into a small water-resistant self contained tube where the RW 10 could be stored in the middle of the rolled up solar panel allowing for a complete self contained kit when the tube's ends were capped.

Messaging Standard

The GuSERS system includes the implementation of a messaging standard. The messaging standard focuses on the low-bandwidth nature of the system and is independent of any specific RW 10 manufacturer that may be used now or in the future.

Any messaging standard exists only because of a shared definition.

An example of a messaging standard as it relates to bi-directional satellite devices, and which is the preferred embodiment is described as follows.

Even though many associate low-bandwidth with dial-up connections of 14.4 K or 33.6 K bps (bits per second), we have focused on even lower connection speeds of 4800 bps or 9600 bps and a maximum of about 300 characters in each entire message (package size).

Due to the relatively small message package size, the messaging standard is extremely conservative in design and extremely focused on the type of information that is sent and received from the RW 10.

The following information is communicated in each message, namely: an identifier of the RW 10, the date and time when the message was composed, the geographical location of the device when composed, a category code which allows information to be grouped and collated, and finally some short text field where the user can provide some free-form text information.

The RW Identifier code (RWI) identifies the pager and the user. This information can be used for several purposes including trending and security authorization of the data. It is important to be able to associate the RWI with authorized users who would be authorized to view its information. The RWI can also be used in conjunction with geographical information to graph where the RW's user was traveling, if in fact the user is mobile.

The date and time of message creation is important due to the fact there are actually three potentially relevant time aspects to a message. The first time aspect is when the message is actually created. The second time aspect is when the message is actually sent and received by the central information management system (otherwise known as the transit time). Once the message is sent from the RW 10 there is an offset time before the message is actually received by the central web-based information management system 60. This offset time may vary for a variety of reasons including delays with the satellite provider 25 or delays accessing with the Internet gateway 40.

The creation time and the transit time may differ based upon several factors such as no satellite being in view, the RW having enough power to create the message, but not enough to send it, or the message not being sent for a variety of reasons.

The third time aspect of the message is when the message is actually viewed by an authorized user through the associated information management system 60. In order to help facilitate the final time aspect, the information management system uses a notification strategy to report data by exception. This strategy includes the development of a rule based database engine integrated with email notification. This allows authorized users of the information management system to set up rules which provide an alert upon the receipt of specific types of messages. These rules can be set up based upon the RWI combined with or without a specific category code or words in the free text.

Included with the date and time element for the message is geographical information indicating where the message was created. The location is recorded as longitude and latitude and is embedded in the message. The RW 10 may have a built in Geographical Positioning System (GPS) receiver and system, and the geographical coordinates can then be embedded into the message based on the last GPS position of the RW 10. Before a message is created, if the RW 10 has traveled any distance from the last GPS position taken by the RW 10, a new GPS position should be taken by the RW 10 to provide an accurate GPS position for the message being sent.

Category codes are also included in the preferred message. These category codes provide a high level description of the message and can be used by the information management system to group and collate the individual messages. These category codes can be created and modified based on specific planned uses of the GuSERS system. A preferred example of this is an individual project that used the GuSERS system to report on a specific project. Therefore, category codes were developed that were specific to that individual project. Another important aspect of the category codes was the ability for “acknowledgement”. That is, to have the system send back a message to the RW 10 acknowledging that the message was received by the information management system. This is a useful feature when the user is in a remote environment and wants to ensure that the message was successfully received.

The messaging standard further includes a free text element. This allows the user to enter other information the meaning of which may not be captured by a category code. A key consideration to note is that the message size is constrained to ensure that the message continues to be low-bandwidth, therefore the message itself can only be about 170 characters in length (with a threshold maximum package size of 300 characters, depending upon the pager or text-messaging system developed). This is comparable to text messaging that is commonly used on cell phones.

An example of an entire message once it is received by the web-based information management system from the RW appears as follows:

| | |
|---|---|
| Date: | 24 Aug 2005 17:50:43 +0000 |
| From: | GUSERS2@gusers.org |
| Reply-To: | GUSERS2@gusers.org |
| Subject: | [GLOBALGRAM:SAT = 13] |
| To: | GUSERSDEVICE@GUSERS.ORG |

OT

00 18.46N, 032 33.01E, 3741FT, WGS84, 01:53:50PM, 24AUG05

DAY 1: GLOBAL HEALTH ISSUES DISCUSSED.

The actual message that will be transmitted to a satellite 20 by the RW 10 in the embodiment will be the following (message size is 85 characters)

OT

00 18.46N, 032 33.01E, 3741FT, WGS84, 01:53:50PM, 24AUG05

DAY 1: GLOBAL HEALTH ISSUES DISCUSSED.

Internet-Based Information Management System

The GuSERS system includes an information management system otherwise known simply as the GuSERS web server. The GuSERS web server is designed around a typical web server architecture consisting of a web server and a database server. This preferred embodiment includes the use of java server pages functioning with an Oracle database.

The GuSERS web server of the preferred embodiment also includes a web-based Geographical Information System (GIS) that serves as a map server. The map server is embedded into the application and serves as a visualization tool for showing geographical location corresponding to where the messages were sent.

The GuSERS system of the preferred embodiment was designed around the concept of managing the information that would be received from the field from the RWs. These messages are received by a standard messaging engine, such as a POP3 email server or other transaction gateway (messaging interface, web service, etc.) from the satellite pager messaging service provider. The GuSERS system polls this POP3 email server at pre-set intervals to extract messages. The messages are then parsed by the GuSERS system and put into a relational database. If for any reason the messages cannot be parsed, they are placed into an error log where an administrator of the GuSERS system manually parses the message to store the message's information in the database.

The message is received into the GuSERS system 60 and only authorized users have access 50 to this information. User profiles can be created to allow access to only specific data, either based on location, category code or RWI. The latter is added so that multiple organizations can use the GuSERS system without having the concern that all of their information is sharable with or accessible by other users of the system. Even though this is considered to be a drawback to the concept of a system collecting data from multiple data sources and sharing this information with interested parties, it is viewed as an important component of the system of the preferred embodiment that needs to be added to permit the personnel of many different organizations to be co-ordinated as users of this system.

A programmable Intelligent System engine is implemented to allow authorized users to create such things as email alerts relative to specific messages that are triggered when certain parameters are met by information in a message. These triggers can be based upon the combination of the RWI, a specific geographical region or the category code, for example. The GuSERS system also allows users to send messages or commands to an individual or group of RWs 10, 10a. The commands are messages that are interpreted by the PDA to alter the behaviour of the application currently receiving the message (such as, but not limited to, by displaying a response or an agent).

Other Intelligent System applications can include data mining, simulation or some other form of artificial intelligence.

Due to the nature of the information that may be collected, the GuSERS system of the preferred embodiment implements several security functions, such as authorized login and a complete audit log of every webpage view by a user. The logging capability of the GuSERS system saves every message that was either sent or received.

Further embodiments of the GuSERS system may include the following optional features:

The GuSERS system may include a distributed architecture where parallel systems can be installed in other locations such as developing countries, allowing the advantage for remote access.

Expansion of the available sources of information either through internet feeds or other devices as they become available. Examples of this would include other information that could be feed by governmental organizations or non-governmental organizations.

The addition of simulation capabilities that would allow users to develop models of certain areas and simulate activities and to train. Examples of this include the ability to simulate transportation routes and their safety or condition as they related to humanitarian relief or the efforts of a disease outbreak from village to village.

The ability to interface to remote devices such as water level indicators or weather stations.

The ability to “pre-load” a PDA in the RW 10 with a number of applications and language capabilities which can be altered by the remote user or by a command received by the GuSERS Information Management System.

The ability to track remote user errors to determine if there is an interface or training issue with the PDA application or the RW 10.

Multiple modes of battery charging permitting use of any source of available energy (wind, sun, thermal electric, gas or diesel motor, local sources of electrical power).

RW 10 to RW 10 messaging.

The Web-server has numerous features including:

satellite overpass optimization; and

Rules engine for alarm and event or task triggers.

Environmental Factors

The GuSERS system may operate in a closed loop environment meaning that a message can be sent from the RW 10 in an isolated area where a telecommunications and electrical infrastructure does not exist and that that the message can be successfully received by the internet-based information management system 60 and a corresponding message sent back to the RW 10, hence, representing a “closed loop” information management system.

The GuSERS RWs 10 may operate in a variety of environments including locations where a cellular phone network is unavailable and where geographical obstacles exist such as remote mountain ranges.

In cases where the satellite 20 is not in view of the RW 10, transmission of messages may be delayed (latency). This problem can be partially mitigated by knowing when the satellites 20 will be in sight of a particular RW 10. The satellite over pass times can be downloaded into the PDA of the RW 10 so a user will know when a message can be either sent or received.

Another factor which contributes to latency is that in certain regions of the world the satellite provider operates on a store and forward 25 approach. This approach is used whenever a complete connection 40 between the satellite service provider ground station, the satellite over the RW and RW 30 cannot be established. The store and forward 25 approach allows the RW 10 to send a message to the satellite 30, the satellite then stores and holds onto that message 25 until it can relay it to a ground station 40.

An advantage of the store and forward approach is to greatly reduce the cost of the overall system. Constant connectivity between the RW 10 and the satellite 20 is not a requirement in such a GuSERS. This asynchronous approach also keeps the cost of the system reasonable enough that it can be applied to developing countries and monitor an entire geographic region at an economical price.

When the RW 10 is in a geographical area that requires a store and forward approach a software methodology can be introduced within the GuSERS Information Management System to offset some limitations of the store and forward approach, by keeping track of which satellites are most likely in the area of the RW 10 and then sending the messages to all those satellites to ensure that the RW 10 receives the message from the first satellite that it is able to connect with. This helps ensures that the RW 10 receives any message on the first pass.

The PDA in a RW 10 may include help features and functions or standard operating procedures to allow users to more easily use the system.

The GuSERS Information Management System also had a query interface that allowed a user at an access point 50 to query the message database in the system 60 for such attributes as date and category code.

Particular Embodiments

The following describe examples of particular embodiments of the present invention:

A bi-directional/uni-directional gusers communication system consists of

Health Monitor Provider Example which Consists of:

1. Health Care Provider Telecommunications Means:
for the health care provider to communicate with the Communication Device Service (RW) Provider Means.

2. World Health Care Personnel:
for the decisions regarding the management of the disaster.

3. GuSERS Satellite Message Record Database:
for the archiving and retrieval of satellite messages.

4. GuSERS Web Server Software:
to Analyze and/or modify the messages and to activate alarms and exceptions based on algorithms.

5. Hardware:
to Provide a Computing environment for the GuSERS Software.

Interface or Sampling Example:

A PDA interface, computerized device or Sampling device such as a weather station which gathers the local environment and reports data by schedule or exception.

A Bi-Directional Pager Example which consists of a:

1. Satellite (i.e. satellite, cellular, terrestrial network, etc.). Pager Receiver Means
For the pager to receive data from the Satellite Pager Service Provider Transmitter Means or other communication Service Provider (i.e. satellite, cellular, terrestrial network, etc.).

2. Satellite (i.e. satellite, cellular, terrestrial network, etc.) Pager Transmitter Means:
For the pager to transmit data to the Satellite Pager Service Provider Receiver Means or other communication Service Provider (i.e. cellular, terrestrial network, etc.).

3. Satellite (i.e. satellite, cellular, terrestrial network, etc.) Pager Service Provider Receiver Means:
For the Pager Service Provider to Receive data from the Pager Transmitter Means or other communication Service Provider (i.e. cellular, terrestrial network, etc.).

4. Satellite (i.e. satellite, cellular, terrestrial network, etc.) Pager Service Provider Transmitter Means:
For the Pager Service Provider to transmit data to the Pager Receiver Means or other communication Service Provider (i.e. cellular, terrestrial network, etc.).

5. Satellite (i.e. satellite, cellular, terrestrial network, etc.) Pager Service Provider Telecommunication Means:
For the Pager Service Provider to establish communications with the GuSERS Web-server or other communication Service Provider (i.e. cellular, terrestrial network, etc.).

PDA Interface Example which consists of:

1. Sampling Interface Means:
for interfacing to the sampling means.

2. User Interface Means:
for displaying of accepting data to the user.

3. Storage Means:
for storage of data for analysis or transmission or reception to the Service Provider Means Via the Pager Means.

4. PDA Means:
Encryption/decryption Means;
Algorithm Means;
Software/Firmware Means.

5. Bi-directional Pager Interface Means:
for communication between the PDA Means and the Pager Means.

Power Supply Example which consists of:

1. Power Source Means;

2. Power Conversion Means;

3. Power Storage Means; and

4. Power Management Means.

The system of this invention has many applications from global surveillance of disaster and disease to remote monitoring and control of commercial assets. There are also some US Homeland Security applications.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for asynchronous messaging between
a. an end-point unit comprised of:
i. Programmable computer
ii. Memory
iii. Power supply
iv. Local I/O for interface with user or sensors
v. Telecommunication capability
And
b. a data-management system comprised of:
i. a messaging system
ii. a message translation system
iii. a data-base engine
iv. a programmable interface with the data-base engine to provide integration of collected data and previously stored data sets to provide reports to system users
v. a Geographic Information System
vi. a system-user I/O and
vii. Telecommunications capability
where the Telecommunications capability of the end-point unit can be used to either send or receive messages to or from the data-management system, and
where the Telecommunications capability of the data-management system can be used to either receive or send message from or to the end-point unit.

2. The system of claim 1 for asynchronous simply-structured messaging between an end-point unit with a power supply which is independent of a utility grid, and where the I/O for sensors can collect and include information from a sensor chosen from the following list: GPS, meteorological, biometric, electrical, magnetic, audio, visual in a simply-structured message; and a data-management system with which the end-point unit communicates, where the system-user I/O includes an interface permitting a system-user to view data inputted via an end-point user's messages, integrated with other information in the data-base which may be one or more of: GIS information, data-point clustering analyses, trend analyses, alert messages generated by rules applied to end-point user data and other data; and the communication system between the end-point unit and the data-base system being capable of communication transactions either to the data-base from the end-user unit or vice-versa.

3. The system of claim 1 used for remote public healthcare monitoring.

4. The system of claim 1 used for remote management of mobile equipment

5. The system of claim 1 used in SCADA operations and management of static equipment and systems.

6. The system of claim 1 used for remote surveillance of natural phenomena programmed to provide distant early warning of natural disasters.

7. The system of claim 1 used for remote surveillance for security purposes.

8. The system of claim 7 where messages are utilized to arm and/or deploy weapons.

9. A thin message of under 300 characters in a protocol for use in an asynchronous messaging system with a minimum set of essential data elements:
a. date and time
b. sending unit identification
c. intended recipient address
d. location of sending unit at or near transmission time
e. at least one category code following pre-defined short format
f. free text.
